(19) United States
(12) Patent Application Publication
(10) Pub. No.: US 2008/0041277 A1
(43) Pub. Date: Feb. 21, 2008

(54) FLUORIDE-CONTAINING HYDRAULIC CEMENTS AND METHODS OF MAKING THE SAME

(75) Inventors: Pradip, Pune (IN); Beena Rai, Pune (IN); Sathish Ponnurangam, Pune (IN); Prakash Chand Kapur, Pune (IN); Ali Unal, Export, PA (US); Roy Allan Cahill, Hot Springs, AR (US); Joseph L. Norton, Hot Springs, AR (US); Judith Ann Stenack, Boonville, IN (US); Vivek Sharma, Noida (IN)

Correspondence Address: INTELLECTUAL PROPERTY, ALCOA TECHNICAL CENTER, BUILDING C, 100 TECHNICAL DRIVE, ALCOA CENTER, PA, 15069-0001, US

(73) Assignee: Alcoa Inc., Pittsburgh, PA (US)

(21) Appl. No.: 11/835,076

(22) Filed: Aug. 7, 2007

Related U.S. Application Data
(60) Provisional application No. 60/822,035, filed on Aug. 10, 2006.

(51) Int. Cl. C04B 9/06

(52) U.S. Cl. 106/683

(57) ABSTRACT

Fluoride-containing hydraulic cements, raw mixtures for producing fluoride-containing hydraulic cements and methods of producing the same are provided. The raw mixture comprises a fluoride source, a calcium oxide source and a silicon oxide. The fluoride source may be a fluoride-containing industrial waste, such as spent pot lining, corresponding to a fluoride content of between 0.1 wt % and 15 wt % within the raw mixture. The ratio of producible calcium oxide to silicon oxide within the raw mixture may be at least about 2:1 and the ratio of producible calcium oxide to the sum of silicon oxide and aluminum oxide within the raw mixture may be at least about 1.5:1.

### CROSS-REFERENCE TO RELATED APPLICATION

This application claims priority to U.S. Provisional Patent Application No. 60/822,035, entitled “Fluoride-Containing Hydraulic Cements and Methods of Making the Same” filed Aug. 10, 2006.

### FIELD OF THE INVENTION

The present invention relates to fluoride-containing hydraulic cements and methods of making the same. Waste from industrial processes, such as waste lining materials from aluminum smelters, may be used to produce the fluoride-containing hydraulic cements.

### BACKGROUND OF THE INVENTION

Aluminum is often produced by the Hall-Héroult process, which involves passing a current through a molten mixture of alumina dissolved in cryolite (Na₃AlF₆) to reduce the alumina to aluminum. This process normally occurs in an electrolytic cell comprising a steel shell lined with a carbon cathode and refractory bricks. After a certain period of operation, the carbon cathode deteriorates and it is removed from the cell along with the refractory bricks. These removed materials are referred to as spent pot lining or “SPL”.

A typical electrolytic cell creates about 100 tons of SPL, and the aluminum industry creates SPL waste equal in weight to about 3% of the aluminum made. Indeed, it is estimated that global aluminum smelters produce more than 500,000 tons of SPL each year. SPL has fuel value and contains valuable metals, but it is often classified as a hazardous material due to its cyanide content, and, in some instances, its leachable fluorides.

Various SPL disposal techniques have been developed over the years. One known method of utilizing SPL is in the production of Portland cement (e.g., See “Treatment and reuse of Spent Pot Lining, an industrial application in a Cement Kiln”, Personnet, Pierre B. LIGHT MET (WARRENDALE Pa.), pp. 269-276, 1999). However, the mass percent of SPL that can be utilized in the Portland cement is relatively low, generally less than 1% of the total feed mass. Moreover, cement plants utilizing SPL generally require an environmental re-qualification. Other disposal techniques have been developed, but have not been widely accepted. Thus, large quantities of SPL are still being placed each year in existing waste SPL dumps, such as in regulatory approved landfills.

The safe disposal of SPL presents a challenge to the aluminum production industry, especially in view of increasingly restrictive environmental standards. There exists a need for methods of converting SPL into a non-hazardous waste and/or recovering the valuable materials contained in the SPL and/or utilizing SPL to form a more useful product.

### SUMMARY OF THE INVENTION

In view of the foregoing, a broad objective of the present invention is to provide methods of utilizing and/or disposing of SPL. A related objective is to produce useful compositions that comprise SPL.

In addressing one or more of the above objectives, the present inventors have recognized that significant benefits may be realized by utilizing SPL and other fluoride-containing waste materials in the production of cementitious products. More particularly, the present inventors have recognized that, due to its compositional make-up, SPL is well suited for the production of fluoride-containing hydraulic cements such as fluoride-containing calcium silicate cements.

Tri-calcium silicate, or alite (Ca₃SiO₅), is a major component of Ordinary Portland Cement (OPC). Alinite is similar to alite and electron microscopy alinite phase has been characterized as Ca₁₁(Si_{0.75}Al_{0.25})O₁₈Cl. Studies have indicated that, during formation of alinite, chlorine ions replace a portion of the oxygen ions that would be present in alite. Alite is intolerant of impurities and thus production of OPC from waste materials is often impractical. Conversely, alinite is remarkably tolerant of various impurities due to its unique solid solution structure. In fact, high amounts of impurities may be contained within alinite cements. Thus, alinite-style cements are well-suited for production from waste products.

Alinite cements generally contain calcium oxide, silica, alumina and chlorine. The present inventors have recognized that SPL contains many of these raw components. The present inventors have also recognized that alinite-type cements may be produced using fluorine instead of chlorine. The present inventors have further recognized that SPL is an excellent source of fluorides and, thus, an excellent raw material for the production of fluoride-containing hydraulic cements.

The present inventors have further recognized that many efficiencies may be realized in the production of fluoride-containing hydraulic cements from SPL and other fluoride-containing waste products. For instance, cements produced from SPL may be manufactured at lower temperatures than those required to produce OPC. It is believed that the presence of sodium and fluoride in the SPL acts as a fluxing agent, thereby facilitating the silicate-forming chemical reactions. SPL also generally comprises many of the raw materials used in the production of alinite-type cements, such as calcium, silica and alumina. Hence, the amount of non-waste feed materials, such as limestone or tailing sands, could be reduced using SPL as a feedstock. Additionally, the relatively high amount of carbon in SPL will act as a fuel during production processes, thereby reducing energy input. Thus, substantial benefits may be achieved in the production of fluoride-containing hydraulic cements from SPL. The present inventors have also recognized that fluoride-containing hydraulic cements may also be produced from other materials, such as other fluoride-containing industrial waste products.

In one aspect of the present invention, an inventive raw mixture for producing a fluoride-containing hydraulic cement is provided. The raw mixture includes a fluoride source, a calcium oxide source and silicon oxide. As discussed in further detail below, this raw mixture may be formed and processed to produce a fluoride-containing hydraulic cement.

The fluoride source of the raw mixture may be any suitable source of fluorides, such as fluoride-containing industrial waste. In a particular embodiment, the industrial waste comprises at least some SPL. The amount of fluoride source within the raw mixture should be sufficient to allow formation of the fluorinated calcium silicates, which are an important ingredient of the fluoride-containing hydraulic cements. However, the present inventors have found that excessive fluorides may degrade compressive strength. In this regard, the raw mixture generally comprises fluoride source sufficient to provide at least about 0.3 wt % fluorides, but not greater than 15.0 wt % fluorides in the raw mixture. For example, the raw mixture may contain fluoride source sufficient to provide at least about 0.5 wt % fluorides and not greater than 10.0 wt % fluorides, such as between 1.5 wt % and 5.0 wt % fluorides. In one approach, the raw mixture comprises sufficient fluoride source to provide between 1.5 wt % and 2.5 wt % fluoride within the mixture. In a particular embodiment, the fluoride source is SPL and the mixture comprises sufficient SPL to prepare the fluoride-containing hydraulic cement. In this regard, the mixture may comprise at least about 3 wt % SPL and not greater than 35 wt % SPL, such as between 12 wt % and 20 wt % SPL.

The term “fluorinated calcium silicates” is used herein to refer to fluorine-containing calcium silicates producible in accordance with the present invention. Example, include, but are not limited to, fluoride-containing calcium silicates, fluoride-sulfate containing calcium silicates, fluoride-aluminum containing calcium silicates, and fluoride-sulfate-aluminum containing calcium silicates, without limiting any of such compounds to any particular amorphous or crystalline structure or any particular chemical formulae.

The calcium source may be any source of producible calcium oxide. In one embodiment, the calcium oxide source is at least one of an industrial waste (e.g., SPL), lime and limestone. The raw mixture should comprise sufficient calcium oxide source to enable the formation of the fluorinated calcium silicates. In this regard, the raw mixture generally comprises at least about 40 wt % calcium oxide source and not greater than 95 wt % calcium oxide source.

The silicon oxide within the mixture facilitates production of the fluorinated calcium silicates. The silicon oxide may be included within the fluoride source and/or calcium oxide source or the silicon oxide may be derived from a separate source, such as a silicon oxide source (e.g., tailing sands). For example, the silicon oxide may be derived from the fluoride source, such as an industrial waste source (e.g., SPL). In one embodiment, the fluoride source is at least a partial source of the silicon oxide, wherein little or no additional silicon oxide source(s) is/are required within the mixture.

The amount of silicon oxide that should be present within the mixture is at least related to the amount of calcium oxide within the mixture. In one embodiment, the raw mixture comprises a ratio of producible calcium oxide to silicon oxide of at least about 2:1. Nonetheless, the raw mixture should comprise sufficient silicon oxide to enable the formation of fluorinated calcium silicates. In this regard, the raw mixture generally comprises at least about 0.5 wt % silicon oxide, such as at least about 2 wt % silicon oxide, or at least about 4 wt % silicon oxide. The raw mixture generally comprises not greater than 15 wt % silicon oxide, such as not greater than 12 wt % silicon oxide, or not greater than 8 wt % silicon oxide.

The mixture may also include a sulfate source. The sulfate source may be any suitable source of sulfates useful in producing fluoride-containing hydraulic cements in accordance with the present invention. For example, the sulfate may be a calcium sulfate, such as calcium sulfate hemi-hydrate (plaster of paris), calcium sulfate anhydride or calcium sulfate dihydrate (gypsum), and the raw mixture may contain at least about 0.1 wt % sulfates and not greater than 25 wt % sulfate source. In one embodiment, the raw mixture comprises between about 12 wt % and 17 wt % sulfates.

The raw mixture may also include aluminum oxide. The source of aluminum oxide may be one or more of the fluoride source, the calcium oxide source, a sulfate source and/or a silicon oxide source. For example, SPL may be at least a partial source of aluminum oxide. The source of aluminum oxide may also/alternatively be another source, such as tailing sands or clay. To facilitate production of the fluoride-containing cements, the raw mixture should comprise a ratio of producible calcium oxide to the sum silicon oxide and aluminum oxide of at least about 1.5:1.

In another aspect of the present invention, an inventive method for producing a fluoride-containing hydraulic cement is provided, the method comprising forming a raw mixture, such as the above-described raw mixture, and preparing a fluoride-containing clinker from the mixture. The method may also include the step of producing a fluoride-containing hydraulic cement from the fluoride-containing clinker. The fluoride-containing clinker and/or fluoride-containing hydraulic cement include the fluorinated calcium silicates. As used herein, the term “fluoride-containing clinker” refers to the material produced from heating the raw mixture to a temperature of 750° C. or higher.

As noted above, the raw mixture generally includes a fluoride source to enable formation of fluorinated calcium silicates. This fluoride source may be industrial waste, such as SPL. One particular method useful in conjunction with the present method includes the step of forming a mixture comprising a fluoride source, a calcium oxide source, silicon oxide and, optionally, a another source (e.g., a sulfate source, a silicon oxide source, a metal oxide source).

The forming step may include one or more additional steps, such as the step of preparing a fluoride source from industrial waste. This preparing step may comprising producing fluoride-containing particles from industrial waste to facilitate mixing with one or more other sources. In this regard, the produced particles should be of sufficient fineness (e.g., a fineness of at least about 2000 cm²/g Blaine). The prepared fluoride source may then be mixed with one or more of the calcium oxide source and other sources.

The inventive method also includes the step of preparing the fluoride-containing clinker. The fluoride-containing clinker is generally prepared by at least a heating step, discussed below, and may also include other steps, such as the step of producing a powder from the raw mixture, prior to the heating step. In this regard, the produced powder should be of a sufficient fineness to facilitate other preparing steps that may occur (e.g., to facilitate heat transfer during a heating step). For example, the produced powder may have a predetermined fineness, such as a fineness of at least about 2000 cm²/g Blaine.

As noted, the step of preparing a fluoride-containing clinker will generally include the step of heating the mixture. This heating step generally includes the step of forming fluorinated calcium silicates, but may include other steps, such as an oxidizing step, dehydrating step, a decomposing step and other steps.

It may be desirable to volatilize and/or oxidize various components of the mixture prior to forming fluorinated calcium silicates so as to restrict contamination during formation of the fluorinated calcium silicates. Thus, the heating step may include the step of oxidizing consumables within the mixture (e.g., carbon) and volatilizing impurities within the mixture. In one embodiment, the industrial source is SPL and this SPL is a source of consumables within in the mixture (e.g., carbon). In one embodiment, the oxidizing step occurs at a temperature of at least about 750° C.

It is also desirable to produce the producible calcium oxide within the mixture. In this regard, the heating step may include the step of dehydrating hydrated lime within the mixture and/or decomposing calcium carbonate within the mixture. In one embodiment, the oxidizing and decomposing steps occur in at least partially non-overlapping relation. In a related embodiment, the oxidizing step may at least partially assist the decomposing step. In this regard, one or more of the oxidizing step and the decomposing step may occur at a temperature of at least about 750° C.

In some instances, the oxidizing of consumables and the forming of the fluorinated calcium silicates occurs concomitantly, such as in non-overlapping relation. For example, a majority or all of the oxidizing step may be completed prior to forming fluorinated calcium silicates. In this regard, the forming fluorinated calcium silicates step may occur at an elevated temperature relative to the oxidizing step.

After heating, it is often desirable to further process the fluoride-containing clinker to produce the fluoride-containing hydraulic cement. For example, a powder may be produced from the clinker and/or additives may be added to the mixture, such as a setting time delay agent or strength enhancers. Thus, the inventive method may also include the step of producing a fluoride-containing hydraulic cement from the fluoride-containing clinker.

In another aspect of the invention, methods of facilitating SPL disposal and facilitating cement production are provided. The inventive method includes the steps of forming industrial waste at a first location (e.g., forming SPL at an aluminum production facility), receiving the industrial waste at a second location remote from the first location (e.g., a cement production facility) and completing one or more of the above described forming a mixture and preparing a cement composition steps at the second location.

For example, SPL may be formed at a plurality of aluminum production facilities and this SPL may be transported to a central cement production facility. Numerous efficiencies may be witnessed using such an arrangement. For example, environmental standards will be segregated. This is, environmental standards associated with aluminum production facilities will be separated from environmental standards associated with cement production facilities. Likewise, plant qualification procedures will be segregated. Additional benefits include, for example, a central drop-off location for all aluminum facilities, thereby streamlining transportation scheduling, and a central shipping location for all produced fluoride-containing hydraulic cements, thereby streamlining transportation of such cements to customers.

These and other aspects, advantages, and novel features of the invention are set forth in part in the description that follows and will become apparent to those skilled in the art upon examination of the following description and figures or may be learned by practicing the invention.

### BRIEF DESCRIPTION OF THE DRAWINGS

FIG. 1 is a flow diagram illustrating one method of preparing fluoride-containing hydraulic cements in accordance with the present invention.

FIG. 2 is a flow diagram illustrating various steps that may be completed in accordance with the method illustrated in FIG. 1.

FIG. 3 is a flow diagram illustrating one method of a heating step useful in accordance with the present invention.

FIG. 4 is a flow diagram illustrating one method of producing fluoride-containing hydraulic cements from SPL in accordance with the present invention.

FIG. 5 is a flow diagram illustrating one method of preparing an SPL stock for use in preparing fluoride-containing hydraulic cements in accordance with the present invention.

FIG. 6 is a flow diagram illustrating one method of producing fluoride-containing hydraulic cements in accordance with the present invention.

FIG. 7 is an XRD spectrum of one raw mixture produced in accordance with the present invention.

FIG. 8 is a graph illustrating a heating profile useful in accordance with the present invention.

FIG. 9 is a graph illustrating the 28-day compressive strength of various hydraulic cements produced in accordance with the present invention.

FIG. 10 comprises two graphs illustrating the 3-day and 28-day compressive strength of various hydraulic cements as a function of calcium oxide and silicon oxide in the raw mixture.

FIG. 11 comprises two graphs illustrating the 3-day and 28-day compressive strength of various hydraulic cements as a function of calcium oxide, silicon oxide and aluminum oxide in the raw mixture.

FIG. 12 is a graph illustrating the 28-day compressive strength of various hydraulic cements as a function of fluorine in the raw mixture.

FIG. 13 is a graph illustrating the 3-day and 7-day compressive strength of various hydraulic cements as a function of sulfates in the raw mixture.

FIG. 14 is a graph illustrating the compressive strength of various hydraulic cements as a function of heating temperature.

FIG. 15 is a graph illustrating the effect of borax addition on compressive strength.

### DETAILED DESCRIPTION OF THE INVENTION

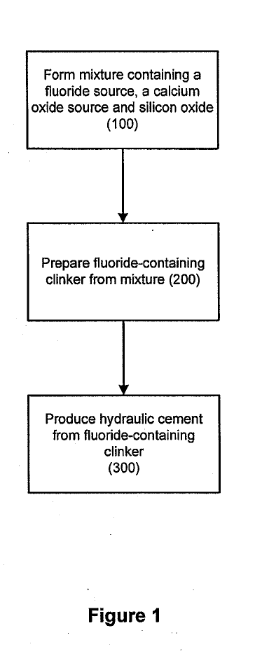

Reference will now be made to the accompanying figures, which at least assist in illustrating various pertinent features of the present invention. Referring now to FIG. 1, one method of preparing a fluoride-containing hydraulic cement is provided, the method including the steps of forming a raw mixture containing a fluoride source, a calcium oxide source, and silicon oxide (100), preparing a fluoride-containing clinker from the raw mixture (200), and producing a fluoride-containing hydraulic cement from the fluoride-containing clinker (300).

The fluoride source utilized in the raw mixture may be any fluoride-containing material suitable to produce hydraulic cements. One useful fluoride source according to the present invention is fluoride-containing industrial waste. One fluoride-containing industrial waste is spent pot lining (SPL) from aluminum production facilities. Other fluoride sources include contaminated bath, dross, floor sweepings and related materials from aluminum production facilities, carbon skimmings from aluminum production facilities, fluoride-rich tailing sands (e.g., fluorspar containing tailings from mineral plants), and fluoride and sulfate containing scrubbing sludges (e.g., from water purification/effluent treatment plants).

As used herein, spent pot lining, or SPL, refers to any waste materials from an electrolytic cell apparatus that may be used in the production of hydraulic cements. Generally, SPL will include a carbon cathode portion, also called the carbon fraction or SPL-C, and various refractory portions, also called the refractory fraction or SPL-R. The typical constituents of each of these fractions and of the SPL as a whole are provided below in Table 1.

TABLE 1

| | Carbon Fraction | Refractory Fraction | Total |
|---|---|---|---|
| Constituent | (SPL-C) | (SPL-R) | (SPL) |
| SiO₂ (wt %) | 0-6 | 10-50 | 10-50 |
| Al₂O₃ (wt %) | 0-10 | 10-50 | 10-50 |
| Al metal (wt %) | 0-5 | — | 0-5 |
| Fe₂O₃ (wt %) | — | 0-3 | 0-3 |
| CaO (wt %) | 1-6 | 1-8 | 1-8 |
| K₂O (wt %) | <0.5 | <0.5 | <1.0 |
| P₂O₅ grams/ton | 0-650 | 0-300 | 0-700 |
| Na (wt %) | 8-12 | 6-10 | 6-20 |
| F (wt %) | 6-10 | 4-10 | 8-20 |
| Cl (wt %) | <0.06 | <0.06 | <0.12 |
| CN (free) grams/ton | 0-2000 | 0-500 | 0-2500 |
| CN (total) grams/ton | 0-5000 | 0-1000 | 0-6000 |

The raw mixture should include sufficient fluoride source to facilitate production of the fluoride-containing hydraulic cement. In this regard, the present inventors have unexpectedly discovered that fluorides are not only desired within the raw mixture, such as for waste disposal purposes, but that sufficient fluorides are required to produce fluoride-containing hydraulic cements having suitable compressive strengths. The present inventors have also recognized that excessive amount of fluoride materials may result in inadequate compressive strengths. Thus, raw mixtures according to the present invention should generally comprise at least about 0.2 wt % fluorides, but not greater than 15.0 wt % fluorides. Raw mixtures may contain at least about 0.3 wt % fluoride, such as from about 0.5 wt % fluoride, or even at least about 1.0 wt % fluoride, but generally not greater than 10.0 wt % fluoride, such as not greater than about 6.5 wt % fluoride, or even not greater than about 5.0 wt % fluoride. One raw mixture according to the present invention comprises between about 1.5 wt % and about 2.5 wt % fluoride.

For raw mixtures utilizing SPL to produce hydraulic cements, the amount of SPL within the raw mixture generally depends on the aluminum oxide, silicon oxide and fluoride content of the SPL, as discussed in further detail below. However, such raw mixtures generally contain at least about 3.0 wt % SPL, such as at least about 5.0 wt % and or at least about 10.0 wt %. In some instances, such raw mixtures may contain a relatively high amount of SPL, such as not greater than 25.0 wt % SPL, or even not greater than 35.0 wt % SPL. Often, such raw mixtures will include between 12.0 wt % and 20.0 wt % SPL.

As noted above, the amount of fluorides within the fluoride source is a factor in determining the amount of fluoride source that can be utilized within the raw mixture. Correspondingly, the amount of fluoride in the SPL is a factor in determining the amount of SPL that can be utilized in the raw mixture. Generally, the amount of SPL within the raw mixture should correspond to a fluoride content within the raw mixture of between 0.1 wt % and 15 wt %, such as between 1.5 wt % and 2.5 wt %.

The raw mixture also contains a calcium oxide source. The calcium oxide source contains producible calcium oxide and may be one or more of lime, limestone, and/or industrial waste, such as SPL. As used herein, producible calcium oxide refers to the amount of calcium oxide that may be produced from one or more sources. For example, the amount of producible calcium oxide in slaked lime is the amount of CaO that will be produced upon dehydration of a given amount of slaked lime. The amount of producible calcium oxide in limestone is the amount of CaO that may be produced from decomposition of a given amount of limestone. The amount of producible calcium oxide in SPL is the amount of CaO that may be freed upon preparing a given amount of SPL for cement production.

The amount of calcium oxide source that is utilized in the raw mixture is related to the amount of calcium oxide in the fluoride source, if any. For example, if the fluoride source is SPL, an amount of producible calcium oxide may be provided from the SPL. Correspondingly, a reduced amount of lime and/or limestone may be required to produce the hydraulic cement. This may provide energy consumption benefits relative to OPC as thermal decomposition of limestone accounts for about 50% of the energy consumed during normal OPC clinkering. Correspondingly, the amount of limestone utilized as the calcium oxide source should be restricted so as to help reduce energy requirements associated with the production of the calcium oxide.

The amount of calcium oxide source that is utilized in the raw mixture is also related to the silicon oxide and aluminum oxide content of the raw mixture. As noted, silicon oxide is required to produce fluorinated calcium silicates. As may be appreciated, either the fluoride source or the calcium oxide may contain silicon oxide. Limestone often contains silicon oxide. SPL generally contains both silicon oxide and aluminum oxide.

The present inventors have found that the amount of silicon oxide, aluminum oxide and producible calcium oxide within the raw mixture is associated with compressive strength. More particularly, the present inventors have unexpectedly found that compressive strength is related to the mass ratio of producible calcium oxide to silicon oxide within the raw mixture (i.e., CaO/SiO₂). The present inventors have found that this CaO/SiO₂ ratio should be at least about 2:1, such as at least about 2.5:1, or at least about 3:1, or at least about 3.5:1, and or even at least about 4:1 and may be as high as at least about 12:1 to produce hydraulic cements having compressive strengths similar to that of OPC.

The present inventors have also unexpectedly found that compressive strength is related to the mass ratio of producible calcium oxide to the sum of aluminum oxide and silicon oxide within the raw mixture (i.e., CaO/(SiO₂+Al₂O₃)). The present inventors have found that this CaO/(SiO₂+Al₂O₃) ratio within the raw mixture should be at least about 1.5:1, such as at least about 2:1, or at least about 2.5:1, or at least about 3:1, and may be as high as at least about 5:1 to produce hydraulic cements having compressive strengths similar to that of OPC.

Sufficient producible calcium oxide should be contained within the raw mixture to promote formation of the fluorinated calcium silicates. In this regard, the raw mixture will generally contain at least about 40.0 wt % of the calcium oxide source, such as at least about 45.0 wt %, or even at least about 50.0 wt % of the calcium oxide source. The raw mixture will generally include not greater than 95 wt % of the calcium oxide source, such as not greater than 85 wt %, or not greater than 75 wt %, or not greater than 70 wt %, or not greater than 65 wt % of the calcium oxide source.

The calcium oxide source may contain additional components and even impurities. During preparation of the hydraulic cements, discussed in further detail below, these additional components and impurities may form other products. In contrast to OPC, hydraulic cements produce in accordance with the present invention are particularly adept at maintaining desired compressive strengths, setting times and other properties, even with the inclusion of such additional components/impurities. Typically, limestone utilized in the production of OPC must meet stringent specifications since various impurities within limestone will affect OPC compressive strength. The present invention does not require such higher quality limestone. Thus, cheaper, low quality limestone may be used as a calcium source within the mixture, which is an additional advantage over OPC.

Sufficient silicon oxide should be contained within the mixture to facilitate production of the fluorinated calcium silicates. The silicon oxide may be included within the fluoride source and/or calcium oxide source. For example, the silicon oxide may be derived from the fluoride source, such as an industrial waste source (e.g., SPL). In one embodiment, the fluoride source is at least a partial source of the silicon oxide, wherein little or no additional silicon oxide sources are required to be added to the mixture. In an alternate embodiment, the silicon oxide may be at least partially derived from a separate silicon oxide source, such as clay, spent refractories, glass cullet, or tailing sands. In this regard, the raw mixture may comprise up to about 15 wt % of a silicon oxide source.

As noted above, the amount of silicon oxide that should be present within the mixture is at least related to the amount of calcium oxide within the mixture. Nonetheless, the raw mixture should comprise sufficient silicon oxide to enable the formation of fluorinated calcium silicates. In this regard, the raw mixture generally comprises at least about 0.5 wt % silicon oxide, such as at least about 2 wt % silicon oxide, or at least about 4 wt % silicon oxide. The raw mixture generally comprises not greater than 15 wt % silicon oxide, such as not greater than 12 wt % silicon oxide, or not greater than 8 wt % silicon oxide.

As noted, the raw mixture may include a sulfate source. The inventors have unexpectedly found that utilizing sulfates may enable the formation of higher compressive strengths. Particularly, the raw mixture may contain at least about 0.1 wt % sulfate source, such as at least about 2 wt %, or at least about 5 wt %, or at least about 10 wt % sulfate source. The raw mixture should also contain not greater than 25 wt % sulfate source, such as not greater than 22 wt %, or not greater than 20 wt %, or not greater than 18 wt % sulfate source. One raw mixture according to the present invention comprises between about 12 wt % and 17 wt % sulfate source.

Useful sulfates according to the present invention include Group I sulfates, such as Li, Na, K, Rb, or Cs sulfates, or Group II sulfates, such as Be, Mg, Ca, Sr and Ba sulfates. Particularly useful among these are calcium sulfates, such as calcium sulfate (CaSO₄), a principle constituent of anhydrite, calcium sulfate hemi-hydrate (CaSO₄.½H₂0), a principle constituent of Plaster of Paris, or calcium sulfate dihydrate (CaSO₄.2H₂O), a principle constituent of gypsum.

Other materials may also be utilized in the mixture. For example, a metal oxide source may be used to facilitate preparation of the fluoride-containing hydraulic cements, such as a source comprising metal oxides of Al and/or Mg. More particularly, an aluminum oxide source, such as bauxite, clay, bauxite residue or spent furnace refractories, may be added to the mixture to provide sufficient aluminum oxide. A magnesium oxide source such as magnesium carbonate may be added to provide sufficient magnesium oxide.

As noted, one embodiment of a method according to the present invention involves forming a mixture of at least a fluoride source and a calcium oxide source. A silicon oxide source, sulfate source and/or metal oxide source may also be included in the mixture. The forming step may include one or more additional steps, such as selecting a predetermined amount of one or more of the fluoride source, calcium oxide source or other sources (e.g., a silicon oxide source, a sulfate source, a metal oxide source) for mixing, preparing one or more of the fluoride source, calcium oxide source or other source(s) for mixing, and mixing the fluoride source with one or more of the calcium oxide source or the other source(s).

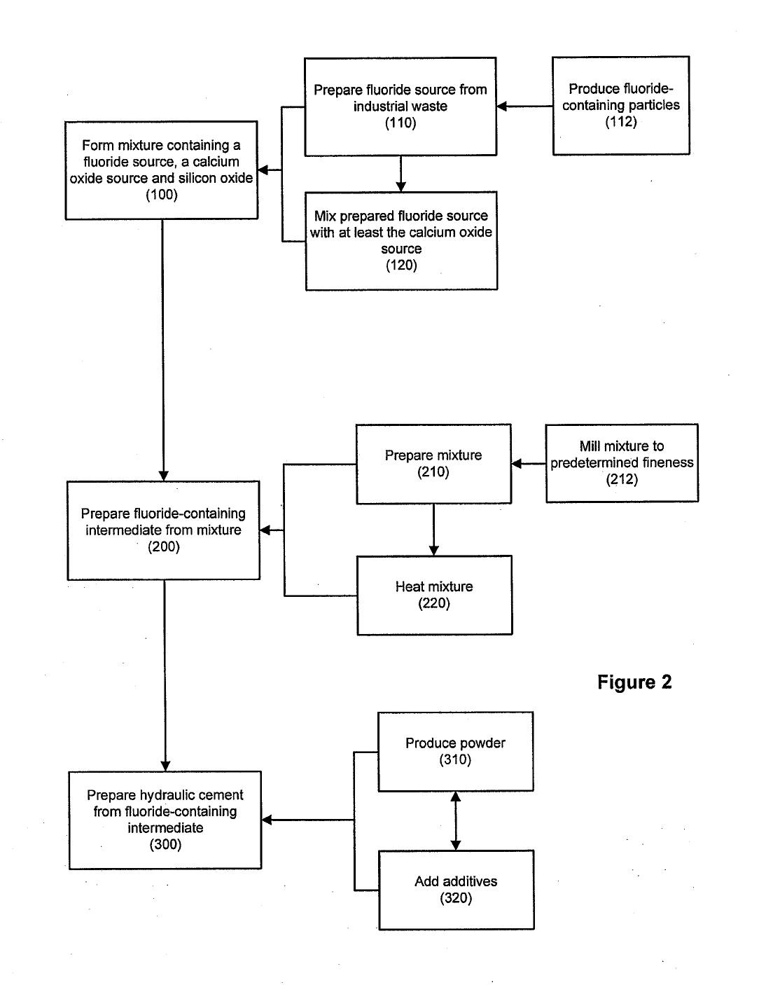

One particular approach for forming the mixture is now described in reference to FIG. 2. In this approach, the forming step (100) includes the steps of preparing a fluoride source from industrial waste (110) and mixing the prepared fluoride source with at least the calcium oxide source (120). The preparing step (110) may include the step of producing fluoride-containing particles from the industrial waste (112). More particularly, the fluoride source may be crushed, ground, milled or otherwise pulverized to produce fluoride-containing particles, such as by ball milling or a similar process. In one embodiment, any produced fluoride-containing particles have a fineness of at least about 2000 cm²/g Blaine so as to facilitate mixing with the calcium oxide source, sulfate source and/or other source(s).

With continued reference to FIGS. 1 and 2, the method further comprises the step of preparing the fluoride-containing clinker from the mixture (200). This preparing step may include one or more additional steps, such as preparing the mixture (210) and/or heating the mixture (220).

The preparing the mixture (210) step may include one or more additional steps useful in preparing the mixture for the heating step (220). It is important that the mixture be of a predetermined quality prior to the heating step. Primarily, it is important that the materials be within a predetermined particle size range so that, for example, the heating step (220) may be efficiently completed. In this regard, the preparing the mixture step (210) may include the step of crushing, grinding, milling or otherwise pulverizing the mixture to a predetermined fineness (212), such as a fineness of at least about 2000 cm²/g Blaine, as determined by a standard Blaine permeability apparatus and in accordance with Indian Standard IS 4031:part 2. Thus, the raw mixture may be ground, milled or otherwise processed to produce a mixture having a predetermined fineness, which facilitates production of the fluoride-containing hydraulic cement.

The preparing the mixture step may include the step of dehydrating the mixture to remove excess water contained therein. In this regard, the mixture may be dried at elevated temperature to dehumidify the mixture prior to the heating step. For example, the mixture may be dried at a temperature of from about 100° C. to about 200° C. to remove excess water contained in lime and/or calcium oxide hemi-hydrate that may be in the mixture.

The preparing step may also include the step of shaping the mixture prior to the heating (e.g., into blocks or pellets). The raw mixture may also be directly heated as an unshaped powder (e.g., in a rotary kiln with suspension preheaters).

As noted, the preparing step (200) may include the step of heating the mixture (220). The heating step (220) facilitates formation of the fluorinated calcium silicates of the present invention. The exact mechanism for formation of fluorinated calcium silicates is not completely understood. However, sufficiently high heating temperatures are generally required for proper kinetics and thermodynamics. Due to the corrosive nature of the liquid phase of the raw mixture and handling problems associated therewith, it is not desirable to heat the mixture to its melting point. Thus, the temperature of the heating step is generally less than the melting point of the mixture, such as a temperature of 25° C. or more below the mixture melting point, or a temperature of 50° C. or more below the mixture melting point.

As noted, the heating temperature should be sufficiently high to provide favorable kinetics and/or thermodynamics. In this regard, the mixture is generally heated to a temperature of at least about 750° C., such as to at least about 800° C., or to at least about 850° C. and more or to at least about 900° C. For example, if the fluoride source comprises SPL, it is often desirable to heat the mixture to a temperature of at least about 800° C., but not greater than 1350° C., such as a temperature from about 1000° C. to about 1200° C.

It is often desirable to volatilize, and/or oxidize various components of the mixture prior to forming the fluorinated calcium silicates so as to restrict contamination during formation of the fluorinated calcium silicates. Thus, the heating step may include one or more additional steps, such as a step of oxidizing consumables within the mixture (e.g., carbon) and/or volatilizing impurities within the mixture.

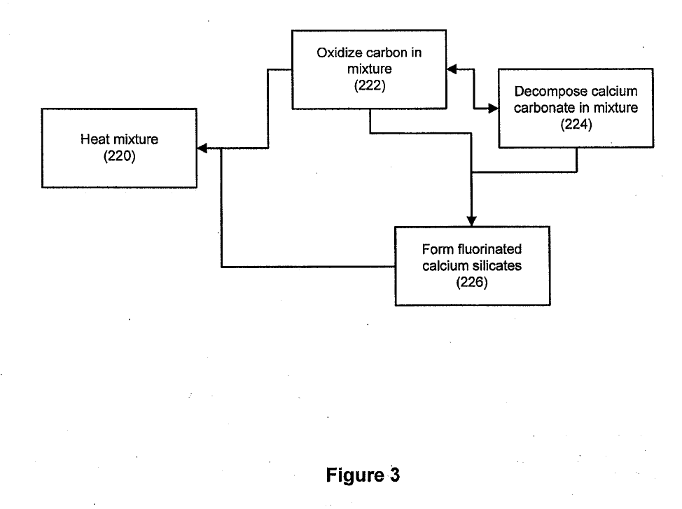

In some instances, it may be desirable to utilize a two-step heating process to prepare the mixture. In this regard, and with reference to FIG. 3, the heating step (220) may comprise a first step of oxidizing consumables (e.g., carbon) in the mixture (222) and a second step of forming fluorinated calcium silicates (226). The oxidizing step (222) may occur at a first temperature and the forming step (226) may occur at an elevated temperature relative to the oxidizing step. Particularly, the oxidizing step (222) may occur within a first temperature range, while the forming step (226) may occur within a second temperature range. These first and second temperature ranges may be at least partially non-overlapping. For example, the first temperature range may be from about 750° C. to about 1000°, such as from 800° C. to about 900° C., and the second temperature range may be from about 950° C. to a temperature that is less than the melting point of the mixture, such as from about 1000° C. to about 1200° C. The heating step (220) may also include the step of decomposing calcium carbonate (224), discussed further below.

The duration of the oxidizing step (222) should be sufficient to oxidize the majority of the consumables contained within the mixture. The duration of the forming step (226) should be sufficient to enable formation of fluorinated calcium silicates. The duration of each of the oxidizing and forming steps is a function of several factors, such as surface area of the mixture and mass and heat transfer associated with the heating step. For example, the oxidizing step may include soaking the mixture at a temperature of at least 800° C. for a first time period and soaking the mixture at a temperature of at least 1000° C. for a second period of time.

In one approach, the fluoride source may comprise SPL, the calcium source may comprise SPL, lime and/or limestone, and the mixture may comprise a sulfate source (e.g., gypsum). In this approach, the mixture may be first heated to at least about 750° C., such as at least about 800° C., for a first heating period and second heated to at least about 1000° C., such as at least about 1100° C., for a second heating period. In the first heating step, oxidation of the carbon and decomposition of the calcium carbonate within any limestone will generally occur. In this regard, energy input requirements may be reduced as carbon within the SPL will act as a fuel during limestone decomposition, thereby assisting in the decomposition of any limestone within the mixture. In other words, the oxidizing step may at least partially assist the decomposing step and the oxidizing step and decomposing step may be at least partially overlapping (e.g., oxidation may begin before decomposing, but may end after the beginning of the decomposing step). The second heating step may also require less energy relative to traditional OPC production. More particularly, the mixture of the present approach may be heated to between 1000° C. and 1200° C. during this second heating step, while traditional OPC production requires heating temperature in excess of 1400° C. Thus, reduced energy input may be witnessed in the production of fluoride-containing hydraulic cement hydraulic cement relative to OPC production. The heating step may be accomplished with any suitable heating device such as a rotary kiln, tunnel kiln, shaft kiln or smelting type furnace.

Referring back to FIGS. 1 & 2, the preparing the fluoride-containing hydraulic cement step (300) may include the step of producing a powder from the fluoride-containing clinker (310). In this regard, the producing a powder step may include the step of crushing, grinding, milling or otherwise pulverizing the fluoride-containing clinker to a predetermined fineness. Particularly, the present inventors have found that the powder produced from the clinker should have a fineness of at least about 3000 cm²/g Blaine, such as at least about 3500 cm²/g Blaine, or at least about 4000 cm²/g Blaine, or at least about 4500 cm²/g Blaine, or at least about 5000 cm²/g Blaine, as determined by a standard Blaine permeability apparatus and in accordance with Indian Standard IS 4031:part 2. Notably, the fluoride-containing clinkers of the present invention are relatively soft and friable and can be ground into a high-quality finished cement with relatively low energy expenditure.

Additives may be utilized during preparation of the fluoride-containing hydraulic cements of the present invention. For example, a setting time delay agent may be combined with the fluoride-containing clinker to facilitate the appropriate setting of the fluoride-containing hydraulic cements. Useful setting time delay agents in this regard include borax, citric acid and tartaric acid. Generally, the setting time delay agent will comprise a relatively small portion of the fluoride-containing hydraulic cement. For example, the setting time delay agent generally comprises not greater than 5 wt % of the fluoride-containing hydraulic cements, such as not greater than about 3 wt %, or even not greater than 1.5 wt % of the fluoride-containing hydraulic cement.

Other additives may also be used. The fluoride-containing hydraulic cements of the present invention generally release lime during hydration. Thus, strength enhancers, such as pozzolana materials (e.g., fly ash, granulated blast furnace slags, volcanic ash) may be utilized in conjunction with the fluoride-containing hydraulic cements of the present invention.

The additives may be added at any suitable point during preparation of the hydraulic cements. For example, setting time delay agents may be added during preparation of a powder, such as during grinding of the fluoride-containing clinker.

The fluoride-containing hydraulic cements produced in accordance with the present invention may comprise qualities similar to OPC, and in some instances qualities that exceed that of OPC. For example, the produced hydraulic cements may exhibit a 3-day compressive strength of at least about 150 kg/cm² and a 28-day compressive strength of at least about 200 kg/cm², such as at least about 300 kg/cm², as determined in accordance with Indian standard specification IS 269. The setting times of the fluoride-containing hydraulic cements are also similar to that of OPC, such as a setting times of 8 hours or less, such as a setting time of not less than 30 minutes and not greater than 300 minutes, as measured by Indian Standard IS 4031: part 4 & 5

The fluoride-containing hydraulic cements produce in accordance with the present invention can be utilized for a variety of purposes, such as in the production of concrete, cold bonded pellets, and other applications in which a hydraulic binder is needed. In the case of concrete, additional additives, such as aggregates, fine and coarse, are generally required. The amount of these additives is dependent upon application.

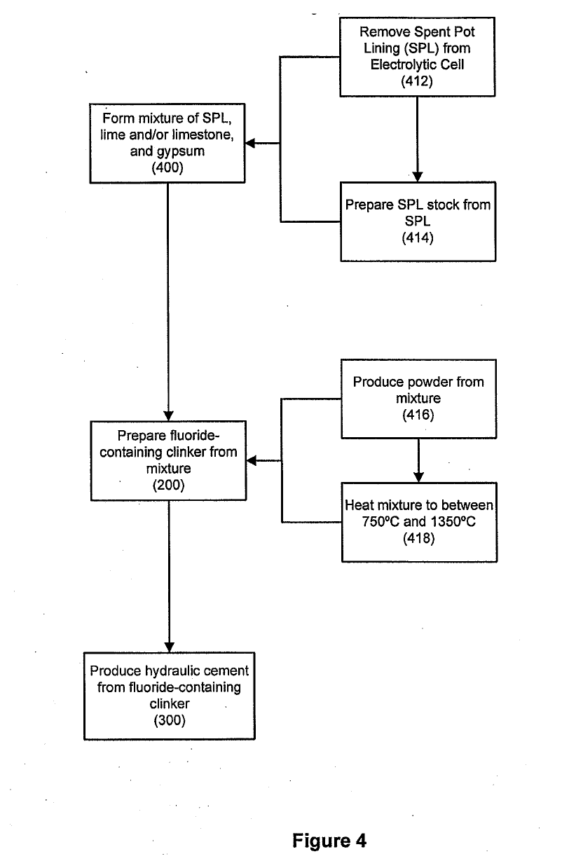

Referring now to FIG. 4, another embodiment of a method useful in accordance with the present invention is illustrated. The method includes the steps of forming a mixture from SPL, lime and/or limestone and gypsum (400) and preparing a fluoride-containing clinker from this mixture (200). The forming step (400) may be achieved in a similar manner as described above in reference to FIG. 1, and thus may include any of the steps, formulations and/or parameters discussed in reference thereto. Similarly, the preparing the fluoride-containing clinker step (200) may be achieved in a similar manner as described above in reference to FIG. 1, and thus may include any of the steps, formulations and/or parameters discussed in reference thereto.

The forming step (400) may include additional steps. For example, the forming step (400) may comprise the steps of removing SPL from an electrolytic cell (412) and preparing an SPL stock from this SPL (414). As noted above, SPL generally comprises two components, the carbon fraction and the refractory fraction. It is generally desirable to process these two fractions in a commingled state, wherein the carbon fraction and refractory fraction are combined during and/or soon after their removal from the electrolytic cell and shipped in a commingled state.

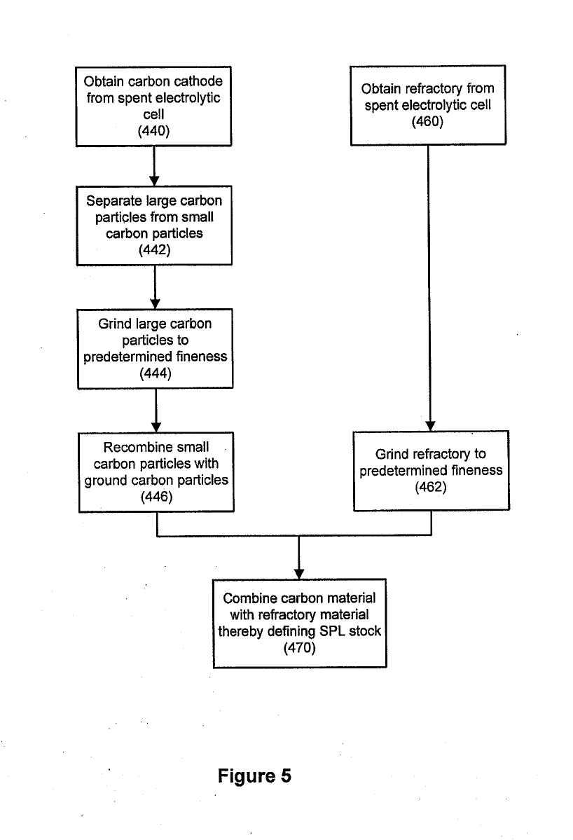

Alternatively, the carbon fraction and refractory fraction may be processed separately. For example, and with reference to FIG. 5, one method of preparing an SPL stock from SPL includes the steps of obtaining the carbon cathode from the spent electrolytic cell (440), separating the relatively large carbon particles (e.g., ≧6 mesh) from relatively small particles (e.g., ≦6 mesh) within the carbon fraction (442), grinding the large particles to a predetermined fineness (444), and recombining the ground particles with the relatively small particles (446). The method may further comprise the step of obtaining the refractory lining from the spent electrolytic cell (460) and grinding the refractory to a predetermined fineness (462). The method may further comprise the step of combining the prepared carbon material with the prepared refractory material to produce the SPL stock (470). The carbon material and refractory material may be combined in any ratio to produce the SPL stock, such as a 1:1 ratio (mass). This ratio may be adjusted as necessary to adjust one or more of the desired fluoride, silicon oxide, aluminum oxide, and/or calcium oxide levels within the SPL, and thus the raw mixture. For example, if a higher producible calcium oxide to silicon oxide ratio is desired, the SPL stock could comprise a greater carbon fraction than refractory fraction.

Referring back to FIG. 4, the preparing a fluoride-containing clinker step (200) may comprise the step of producing a powder from the mixture (416), the mixture having a fineness of at least about 3000 cm²/g Blaine, such as at least about 4000 cm²/g Blaine or even 5000 cm²/g Blaine. The preparing a fluoride-containing clinker step may comprise the step of heating the mixture (418), such as described above relative to FIG. 2. By way of example, the mixture may be heated from between 750° C. and 1350° C. In one embodiment, the heating step (418) includes first heating the mixture to a temperature of at least about 750° C. for a first duration (e.g., to oxidize carbon within the mixture and decompose calcium carbonate within the mixture) and second heating the mixture to a temperature of at least about 900° C. (e.g., to form the fluorinated calcium silicates) for a second duration.

The producing a fluoride-containing hydraulic cement step (300) may be achieved in a similar manner as described above in reference to FIG. 1, and thus may include any of the steps, formulations and/or parameters discussed in reference thereto.

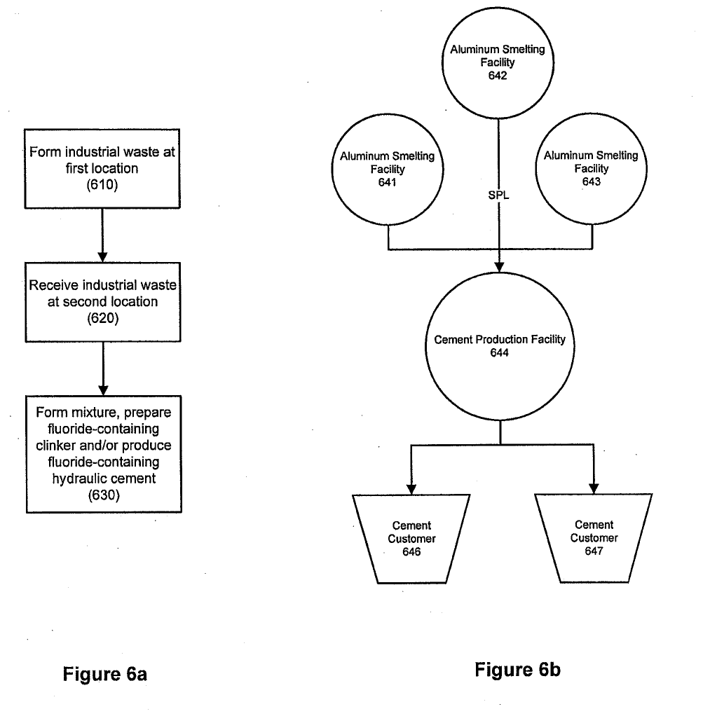

The present inventors have also determined that further economies may be demonstrated in producing fluoride-containing hydraulic cements utilizing a centralized cement production plant to process industrial waste from one or more industrial production facilities. FIG. 6a illustrates one such method for producing fluoride-containing hydraulic cements, the method comprising the steps of forming industrial waste at a first location, such as an aluminum smelting facility, receiving such industrial waste at a second location remote from the first location, such as a cement production facility, and completing one or more of the above described forming, preparing and/or producing steps at the second location.

In a particular embodiment and as illustrated in FIG. 6b, industrial waste comprising SPL from a plurality of aluminum production facilities 641, 642, 643 is transported to a central cement production facility 644 and one or more of the above described steps (e.g., forming a mixture, preparing a hydraulic cement and steps related thereto) are completed at the cement production facility. Efficiencies realized from such methods include a central receiving location for all industrial waste and a central production location for the hydraulic cement. Other efficiencies included segregation of environmental requirements and qualifications between the industrial waste production location and the cement production location and a central origination point for the transport and delivery of produced hydraulic cements to cement consumers 646, 647.

### EXAMPLES

### Example 1

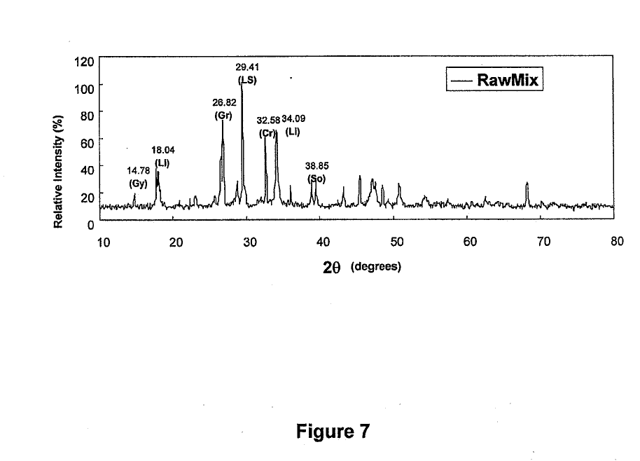

24.8 wt % SPL, 37.3 wt % slaked lime, 24.8 wt % limestone, 12.5 wt % gypsum and 0.6 wt % tailing sands were mixed together and ground in a ball mill to a fineness of 5391 cm²/g Blaine. The XRD spectrum of this raw mixture is illustrated in FIG. 7. The calculated amount of calcium oxide, silicon oxide, aluminum oxide, fluoride and sulfate in the raw mixture is provided below in Table 2. After milling, the mixture was heated to 800° C. for about 2 hours, followed by heating to 1150° C. for about 1 hour. The clinkered mixture was ground to a fineness of about 5000 cm²/g Blaine and a hydraulic cement was made from the ground, clinkered mixture. The 3-day, 7-day and 28-day compressive strengths of the hydraulic cement were measured and are provided below in Table 2.

TABLE 2

| | | | | | | Compressive strength, | | |
|---|---|---|---|---|---|---|---|---|
| | Calculated raw mix design, | | | | | (kg/cm²) | | |
| | (wt %) | | | | | 3 | 7 | 28 |
| Mixture | CaO | SiO₂ | Al₂O₃ | F | SO₃ | day | day | day |
| W7 | 39.8 | 5.2 | 4.5 | 3.2 | 5.8 | 120 | 171 | 204 |

### Example 2

Various amounts of SPL, lime, limestone, gypsum, and, in some instances, tailing sands were mixed together. The amount of each of these materials in each of the raw mixtures was measured and the amount of CaO, silica, alumina, fluorine and sulfate in each of the raw mixtures was calculated. These amounts are provided below in Table 3.

TABLE 3

| | Composition (raw mix constituents), wt % | | | | | Calculated raw mix design, wt % | | | | |
|---|---|---|---|---|---|---|---|---|---|---|
| Mixture | SPL | Limestone | Lime | Gypsum | Tailings sand | CaO | SiO₂ | Al₂O₃ | F | SO₃ |
| 1 | 16.3 | 51.4 | 18 | 14.3 | — | 41.6 | 5.6 | 3.2 | 2.1 | 7.9 |
| 4 | 14.6 | 63.4 | 7.7 | 14.3 | — | 40.8 | 6.1 | 2.8 | 1.9 | 7.9 |
| 15 | 19.7 | 53.1 | 12 | 14.3 | 0.9 | 38.7 | 6.4 | 3.5 | 2.6 | 7.9 |
| 16 | 12.9 | 53.1 | 18.9 | 14.3 | 0.9 | 42.9 | 6.6 | 2.7 | 1.7 | 7.9 |
| 20 | 18 | 66.9 | 0.9 | 14.3 | — | 38.2 | 6.1 | 3.2 | 2.3 | 7.9 |
| 29 | 12.9 | 58.3 | 11.1 | 14.3 | 3.4 | 40.5 | 9.2 | 2.6 | 1.7 | 7.9 |

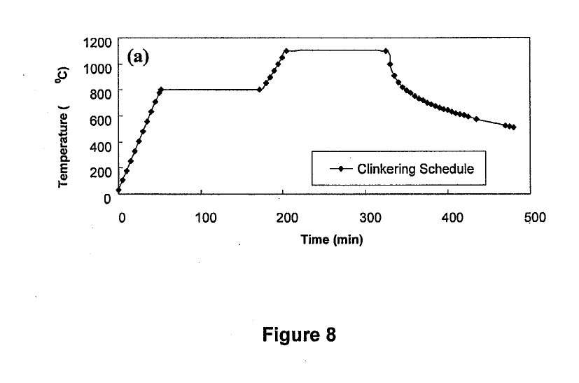

Each of these mixtures were ground to a fineness of about 2000 cm²/g Blaine and shaped into 35×35 mm blocks of 15 mm thickness. These blocks were heated at about 800° C. for 2 hours, followed by heating at about 1100° C. for 2 additional hours, as illustrated by FIG. 8. Each of these cementitious compositions were ground to a fineness of about 5000 cm²/g Blaine. Test cubes were prepared in accordance with Indian standard IS 4031:part 6 from each of the ground cementitious compositions and their 3-day and 28-day compressive strength were measured, the results of which are provided below in Table 4.

TABLE 4

Compressive strength*, kg/cm2

| Mixture | 3 days | 28 days |
|---|---|---|
| 1 | 257 | 380 |
| 4 | 158 | 286 |
| 15 | 141 | 309 |
| 16 | — | 299 |
| 20 | 38 | 350 |
| 29 | 123 | 413 |

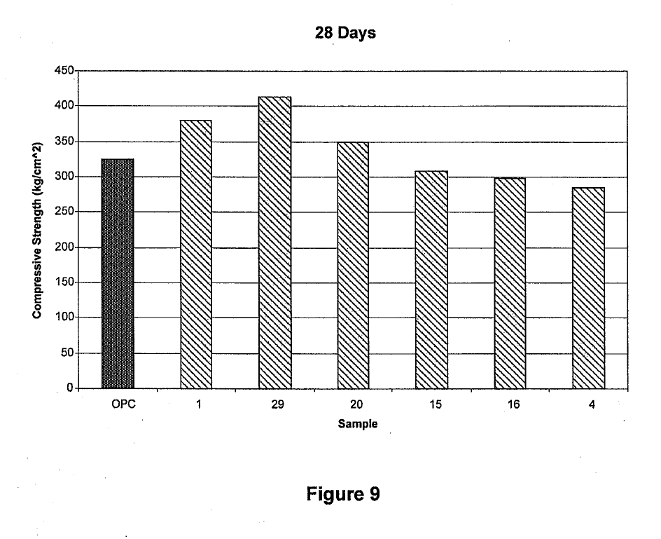

FIG. 9 illustrates the 28-day compressive strength of each of the hydraulic cements as compared to ordinary Portland cement (OPC) requirements. Many of the test cubes had a 28-day compressive strength that met or exceeded OPC 28-day compressive strength requirements.

### Example 3

Various amounts of SPL, lime, limestone, gypsum, and, in some instances, tailing sands were mixed together and the amount of calcium oxide, silica, alumina and fluoride in of each of these mixtures was calculated. Each of these mixtures were ground to a fineness of about 5000 cm²/g Blaine and shaped into 35×35 mm blocks of 15 mm thickness. Each of these blocks were heated at 800° C. for 2 hours, followed by heating at 1100° C. for 2 additional hours. Each of these produced cementitious compositions were ground to a fineness of about 5000 cm²/g Blaine. Test cubes were prepared from each of the ground cementitious compositions.

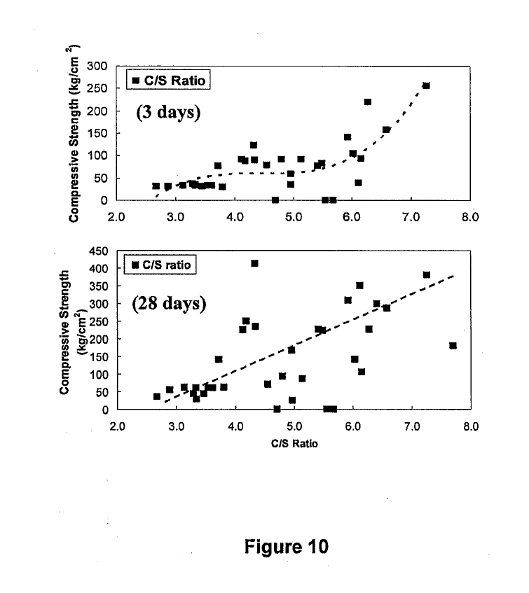

The calcium oxide to silica ratio (C/S) for each of the raw mixtures was calculated and the 3-day and 28-day compressive strengths for each test cube was compared to that mixture's C/S ratio. FIG. 10 illustrates the 3-day and 28-day compressive strengths of these mixtures relative to the C/S ratio. Many test cubes that had a C/S ratio of at least about 3:1 had 3-day and 28-day compressive strengths that met or exceeded the requirements for OPC.

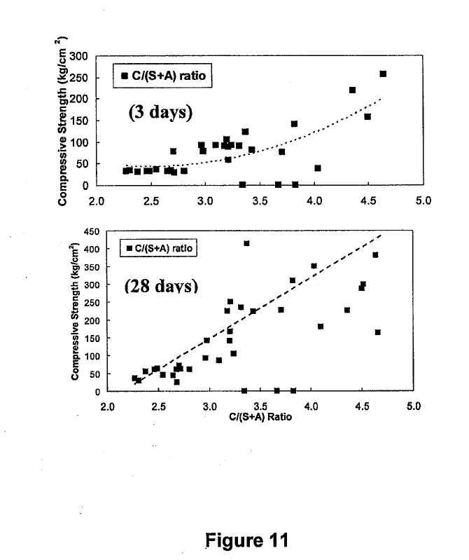

The calcium oxide to the sum of silica and alumina ratio (C/(S+A)) for each of the raw mixtures was also calculated and the 3-day and 28-day compressive strengths for each test cube was compared to that mixture's C/(S+A) ratio. FIG. 11 illustrates the 3-day and 28-day compressive strengths of these test cubes relative to the C/(S+A) ratio. Many test cubes that had a C/(S+A) ratio of at least about 2:1 had 3-day and 28-day compressive strengths that met or exceeded the requirements for OPC.

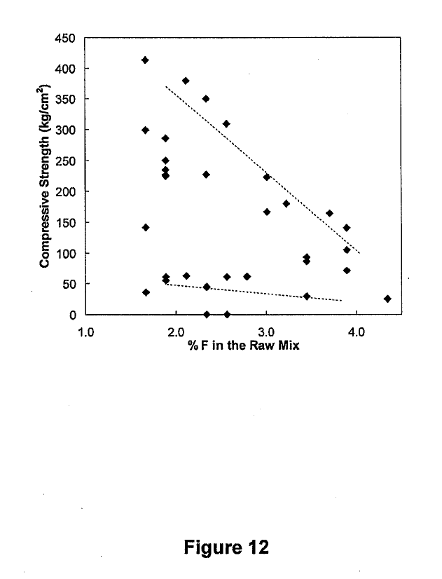

The amount of fluoride in each of the raw mixtures was also compared to the 3-day and 28-day compressive strengths for each test cubes. FIG. 12 is a graph illustrating the 28-day compressive strength of these test cubes relative to the amount of fluoride in each of the mixtures. Many test cubes that contained between 1 wt % fluoride and 4 wt % fluoride had a 28-day compressive strength that met or exceeded the requirements for OPC.

### Example 4

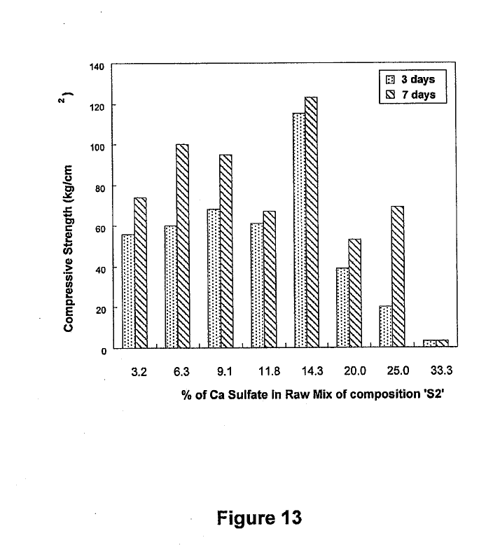

Various amounts of gypsum were utilized in a mixture comprising SPL, lime and limestone. These mixtures were ground and heated. The clinkered mixtures were then ground and test cubes were prepared from each of these ground mixtures. The 3-day and 7-day compressive strengths of each of these test cubes were measured. FIG. 13 is a graph illustrating the 3-day and 7-day compressive strengths of the resultant test cubes compared to the amount of calcium sulfate in the mixture. Raw mixtures comprising between 3 wt % and 25 wt % calcium sulfate exhibited varying compressive strengths. One raw mixture comprising 14.3 wt % calcium sulfate, 28.6 wt % SPL, and 57.1 wt % producible calcium oxide exhibited compressive strengths comparable to OPC.

### Example 5

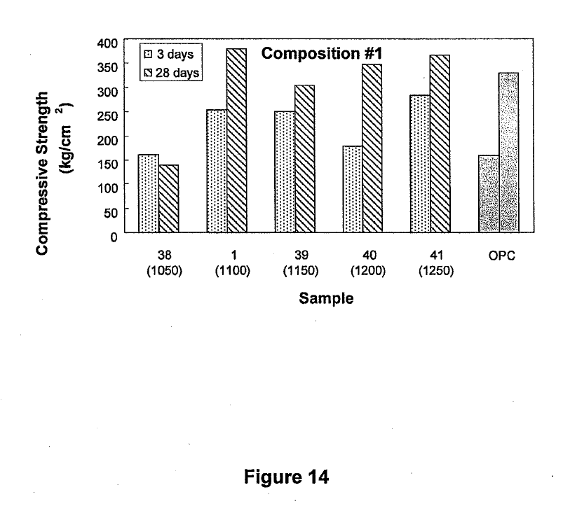

Various batches of Mixture No. 1 from Example 2 were prepared and ground to a fineness of about 2000 cm²/g Blaine. These batches were heated to various temperatures to form the fluoride-containing cement clinkers and the clinkers thus produced were ground to a fineness of about 5000 cm²/g Blaine. Test cubes were made from each of these hydraulic cements and the 3-day and 28-day compressive strengths for each of the test cubes were measured. FIG. 14 is a graph illustrating the 3-day and 28-day compressive strengths of each of the test cubes relative to heating temperature. Temperatures of from about 1100° C. to about 1250° C. yielded hydraulic cements having 3-day and 28-day compressive strengths that were comparable to OPC.

### Example 6

Various batches of Mixture No. 1 from Example 2 were prepared and ground to a fineness of about 2000 cm²/g Blaine. These batches were heated to various temperatures to form the fluoride-containing cement clinkers and the clinkers thus produced were ground to a fineness of about 5000 cm²/g Blaine. Various amounts of borax were ground with the clinkered mixtures. Test cubes were made from each of these hydraulic cements and setting time was measured relative to the amount of borax within each of the ground mixtures. Table 5 illustrates the effect of borax on the setting time of the hydraulic cement. The composition that included 1 wt % borax had a setting time that was within the setting time limits set for OPC.

TABLE 5

| Setting time delay agent, | Consistency, | Setting time, (minutes) | |
|---|---|---|---|
| wt. % | (%) | Initial | Final |
| None | 28 | 9 | ≧15 |
| 0.5% borax | 33 | 24 | ≧30 |
| 1% borax | 33 | 45 | 50 |
| IS specification for | — | Minimum 30 | Maximum 600 |
| OPC (IS 269) | | | |

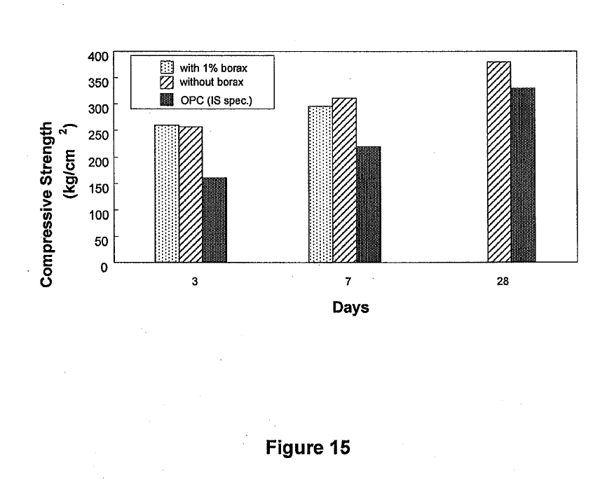

The 3-day, 7-day and 28-day compressive strengths of each of these produced hydraulic cements were also measured. FIG. 15 is a graph illustrating the effect of borax addition on compressive strength. Hydraulic cements including 1 wt % borax had a similar compressive strength to that of OPC and cements prepared without borax.

While various approaches, aspects, embodiments and otherwise of the present invention have been described in detail, it is apparent that modifications and adaptations of those embodiments will occur to those skilled in the art. However, it is to be expressly understood that such modifications and adaptations are within the spirit and scope of present invention.

What is claimed is:

1. A method for producing a fluoride-containing hydraulic cement, the method comprising:
forming a mixture, the mixture comprising:
a fluoride source;
a calcium oxide source; and
silicon oxide; and
preparing a fluoride-containing clinker from the mixture.

2. The method of claim 1, wherein the fluoride source comprises industrial waste, and wherein at least some of the industrial waste comprises spent pot lining from an aluminum metal electrolysis cell.

3. The method of claim 2, wherein the calcium oxide source is selected from the group consisting of SPL, lime and limestone.

4. The method of claim 1, wherein the mixture comprises between about 0.5 wt % fluorine and 6.5 wt % fluoride.

5. The method of claim 1, wherein the mixture comprises a ratio of producible calcium oxide to silicon oxide of at least about 2:1.

6. The method of claim 1, wherein the mixture comprises between 0.5 wt % and 15 wt % silicon oxide.

7. The method of claim 1, wherein the mixture comprises a sulfate source, and wherein the mixture comprises between 12 wt % and 17 wt % of the sulfate source.

8. The method of claim 1, wherein the mixture comprises aluminum oxide, and wherein the mixture comprise a ratio of producible calcium oxide to the sum of silicon oxide and aluminum oxide of at least about 1.5:1.

9. The method of claim 1, wherein the forming step comprises:
preparing the fluoride source from industrial waste; and
mixing the prepared fluoride source with at least the calcium oxide source.

10. The method of claim 9, wherein the preparing the fluoride source step comprises:
producing fluoride-containing particles having a fineness of at least 3000 cm²/g Blaine.

11. The method of claim 9, wherein the preparing the fluoride-containing clinker step comprises:
heating the mixture to a temperature in the range of from at least about 750° C. to less than the melting point of the mixture.

12. The method of claim 11, wherein the heating step comprising heating the mixture to a temperature of not greater than 1350° C.

13. The method of claim 9, wherein the mixture comprises carbon and wherein the preparing the fluoride source step comprises oxidizing the carbon.

14. The method of claim 1, wherein the preparing a fluoride-containing clinker step comprises:
forming fluorinated calcium silicates.

15. The method of claim 1, further comprising:
producing a fluoride-containing hydraulic cement from the fluoride-containing clinker.

16. A mixture useful in producing a fluoride-containing hydraulic cement, the mixture comprising:
a fluoride source;
a calcium oxide source; and
silicon oxide, wherein the mixture comprises at least 0.3 wt % fluoride.

17. The mixture of claim 16, wherein the mixture comprises between 0.5 wt % and 6.5 wt % fluoride, and wherein the mixture comprises between 0.5 wt % and 15 wt % silicon oxide.

18. The mixture of claim 17, wherein the mixture comprises a ratio of producible calcium oxide to silicon oxide of at least about 2:1.

19. The mixture of claim 18, wherein the mixture comprises aluminum oxide, and wherein the mixture comprises a ratio of producible calcium oxide to the sum of silicon oxide and aluminum oxide of at least about 1.5.

20. The mixture of claim 19, wherein the mixture comprises calcium sulfate, and wherein the mixture comprises between about 12 wt % and 17 wt % of the calcium sulfate.
